(19) United States
(12) Patent Application Publication
(10) Pub. No.: US 2004/0143035 A1
(43) Pub. Date: Jul. 22, 2004

(54) Use of gradient copolymers as dispersants to treat pigments and other solids

(76) Inventors: Bernd Goebelt, Wesel (DE); Karlheinz Haubennestel, Wesel (DE); Udo Krappe, Emmerich (DE); Petra Della Valentina, Dinslaken (DE)

Correspondence Address: Schwegman, Lundberg, Woessner & Kluth, P.A., P.O. Box 2938, Minneapolis, MN, 55402, US

(21) Appl. No.: 10/636,319

(22) Filed: Aug. 7, 2003

(30) Foreign Application Priority Data
Aug. 7, 2002 (DE) DE 102 36 133.9

(51) Int. Cl. C08K 9/00

(52) U.S. Cl. 523/200

(57) ABSTRACT

The use as dispersants of gradient copolymers obtainable by living controlled polymerization of ethylenically unsaturated monomers using a non-polymeric monofunctional initiator and possessing a transition from hydrophilic to hydrophobic properties along the polymer chain, by

a) supplying one monomer (I) continuously to a monomer (II) under reaction or

b) supplying one monomer (I) and one monomer (II) at different rates continuously to a reaction vessel for reaction,

with either the monomer (I) or the monomer (II) introducing into the gradient copolymer groups which as they are or after further chemical reaction of the gradient copolymer interact with the solid or solids to be dispersed, and the other monomer introducing into the gradient copolymer groups which are compatible with the liquid or solid dispersion medium, with either the monomer (I) or the products of the further chemical reaction of the monomer (I), on the one hand, or the monomer (II) or the products of the further chemical reaction of the monomer (II) on the other hand, possessing hydrophobic properties and the other monomer in each case or the products of the further chemical reaction of the other monomer in each case possessing hydrophilic properties, the hydrophobic and hydrophilic properties being defined as follows:

hydrophilic properties are present when the solubility parameter is greater than or equal to 22 J^{1/2}/cm^{3/2} and hydrophobic properties are present when the solubility parameter is less than 22 J^{1/2}/cm^{3/2},

with the terms “monomer (I)” and “monomer (II)” embracing mixtures of monomers (I) on the one hand and monomers (II) on the other hand.

### CROSS-REFERENCE TO RELATED APPLICATIONS

This application is a continuation of DE 102 36 133.9 filed Aug. 7, 2002, which application is incorporated herein by reference.

The invention relates to the use of gradient copolymers with a transition from hydrophilic to hydrophobic properties along the polymer chain as dispersants particularly to treat pigments and other solids. The invention further relates to coating compositions and moulding compounds comprising as dispersants gradient copolymers with a transition from hydrophilic to hydrophobic properties along the polymer chain.

In order to bring about homogeneous distribution of solids in a liquid or solid medium, as for example in coating materials, aqueous pigment dispersions or moulding compounds, which for example are thermosetting and thermoplastic polymers, and in order to stabilize them as well, where appropriate, dispersants are added as auxiliaries. For these purposes the auxiliaries must have two different properties. First they are to interact with the surface of the solid in order to facilitate its wetting. This is achieved by means of certain chemical groups referred to as attachment groups. Examples of hydrophilic attachment groups are tertiary amines, ammonium salts, phosphoric esters, carboxylic acid groups, and amide, urethane or urea structures. For aqueous dispersions the attachment groups used can be hydrophobic structures such as alkyl groups, phenyl structures and benzyl structures, for example, as described for example in Adv. Mater. 1998, 10, 1214. Secondly dispersants are to possess areas in the molecule which are highly compatible with the medium. For organic media such areas are for example hydrophobic structures such as alkyl or aryl structures. For aqueous media use should be made of hydrophilic structures which are soluble in water, such as polyethylene glycols or carboxylic acids converted to their salt form.

Monomers which constitute the part of the dispersant that is compatible with the liquid or solid medium are referred to below as “monomers A”. Monomers which carry functionalities or attachment groups which interact with the surface of the solid to be dispersed are referred to below as “monomers B”. These functionalities or attachment groups may also be generated by means of chemical reactions after the polymerization.

Dispersants used are often polymers based on ethylenically unsaturated monomers, such as methacrylates, acrylates or styrenes, for example. In conventional fashion these polymers are obtained by means of free radical polymerization. In such a reaction it is possible to achieve only a random distribution of the monomers A and B in the polymer chain. Such compounds are described for example in U.S. Pat. No. 5,688,858.

With the development of controlled and living polymerization techniques it became possible to generate structured polymers in a simple fashion.

With group transfer polymerization (GTP) it is possible for example to prepare dispersants based on AB block copolymers. Examples thereof are described in EP-A-0 218 436, EP-A-0 329 873, EP-A-0 518225, EP-A-0 323 181 and U.S. Pat. No. 4,925,765.

One method of polymerization which can be used to polymerize a large number of monomers is that of atom transfer radical polymerization (ATRP), described for example in WO 96/30421. Examples of various monomers which can be polymerized or copolymerized using ATRP can be found in Chem. Rev. 2001, 101, 2921. The use of linear polymers prepared by ATRP as dispersants is described in WO 00/40630 and WO 01/44389.

In spite of this new development of dispersants there continues to be an urgent need for improved dispersants.

One object of the present invention was therefore to find a means of providing better dispersions which makes it possible in particular to obtain dispersions with only a low propensity to form foam, which particularly in coating compositions do not give rise to the formation of any specks, while at the same time featuring high gloss, good transparency, and little tendency towards clouding.

Surprisingly it has been found that the object posed is achieved through the use as dispersants of gradient copolymers obtainable by living controlled polymerization of ethylenically unsaturated monomers using a non-polymeric monofunctional initiator and possessing a transition from hydrophilic to hydrophobic properties along the polymer chain, by

a) supplying one monomer (I) continuously to a monomer (II) under reaction or

b) supplying one monomer (I) and one monomer (II) at different rates continuously to a reaction vessel for reaction,

with either the monomer (I) or the monomer (II) introducing into the gradient copolymer groups which as they are or after further chemical reaction of the gradient copolymer interact with the solid or solids to be dispersed, and the other monomer introducing into the gradient copolymer groups which are compatible with the liquid or solid dispersion medium, with either the monomer (I) or the products of the further chemical reaction of the monomer (I), on the one hand, or the monomer (II) or the products of the further chemical reaction of the monomer (II) on the other hand, possessing hydrophobic properties and the other monomer in each case or the products of the further chemical reaction of the other monomer in each case possessing hydrophilic properties, the hydrophobic and hydrophilic properties being defined as follows:

hydrophilic properties are present when the solubility parameter is greater than or equal to 22 J^{1/2}/cm^{3/2} and hydrophobic properties when the solubility parameter is less than 22 J^{1/2}/cm^{3/2},

with the terms “monomer (I)” and “monomer (II)” embracing mixtures of monomers (I) on the one hand and monomers (II) on the other.

The calculation method (incremental method of Hoftyzer-Van Krevelen) and experimentally determined values for the solubility parameters are elucidated in U.S. Pat. No. 6,362,274 B1, J. Applied Polym. Sci. 2000, 78, 639, and in the following monograph: D. W. van Krevelen, “Properties of polymers. Their correlation with chemical structure; their numerical estimation and prediction from additive group contributions”, 3^{rd} edition, Elsevier, 1990, pp. 189-225.

The solubility parameters apply to hypothetical polymers arising only from the monomers (I), mixtures of monomers (I) or the products of a further chemical reaction of these monomers or arising solely from the monomers (II), mixtures of monomers (II) or the products of a further chemical reaction of these monomers.

The term “products of a further chemical reaction of these monomers” refers to the monomer which is incorporated into the polymer and has come about as a result of one or more further chemical reactions. One example of this is the introduction into the polymer of methacrylic acid as a reaction product of t-butyl methacrylate, which is polymerized as the monomer and subsequently hydrolysed to the desired methacrylic acid. In this case the solubility parameter to be used is that of methacrylic acid and not that of the t-butyl methacrylate.

These dispersants with a transition from hydrophilic to hydrophobic properties along the polymer chain exhibit better dispersing properties than random copolymers and block copolymers. In comparison to dispersants having hydrophilic and hydrophobic properties based on block copolymers such dispersants with a gradient structure have much less of a foam stabilization effect. Since within the dispersing equipment any foam reduces the volume for the millbase and so reduces the throughput a low level of foam stabilization on the part of the dispersant is particularly desirable.

Gradient copolymers are copolymers composed for example of two monomers A and B in whose individual chains there is a gradient in the distribution of the monomer units along the chains. One end of the chain is rich in A units and the other in B units. These polymers are preparable by living controlled polymerization methods. Examples of such polymerization methods are:

1) controlled free-radical polymerization with xanthogenates as polymerization regulators, as described for example in WO 98/58974,

2) controlled free-radical polymerization with dithioesters as polymerization regulators, as described for example in WO 98/01478,

3) controlled free-radical polymerization with dithiocarbamates as polymerization regulators, as described for example in WO 99/31144,

4) controlled polymerization with nitroxyl compounds as polymerization regulators (NMP), as described for example in Chem. Rev. 2001, 101, 3661,

5) controlled free-radical polymerization with tetraphenylethane, as described for example in Macromol. Symp. 1996, 111, 63,

6) controlled free-radical polymerization with 1,1-diphenylethene as polymerization regulator, as described for example in Macromolecular Rapid Communications, 2001, 22, 700,

7) atom transfer radical polymerization (ATRP), as described for example in WO 96/30421,

8) controlled free-radical polymerization with iniferters, as described for example in Makromol. Chem. Rapid. Commun. 1982, 3, 127,

9) group transfer polymerization (GTP) as described for example by O. W. Webster in Encyclopedia of Polymer Science and Engineering, Volume 7, H. F. Mark, N. M. Bikales, C. G. Overberger and G. Menges, eds., Wiley Interscience, New York 1987, page 580 ff.,

10) controlled free-radical polymerization with organocobalt complexes, as described for example in J. Am. Chem. Soc. 1994, 116, 7973.

Polymerization methods 1)-3) are reversible addition fragmentation chain transfer processes, referred to herein as “RAFT” polymerizations.

Preparation examples for gradient copolymers can be found for example in WO/9718247 and J. Phys. Org. Chem. 2000, 13, 775. Two methods are described therein:

1) All of the monomers are introduced at the start and by utilizing the different copolymerization parameters of the monomers a gradient is generated along the polymer chain.

2) By continuously supplying one monomer to the other monomer during the reaction or by two different metering rates of the two monomers a gradient can be generated along the polymer chain.

Method 2) is the method by which the dispersants with a gradient copolymer structure that are to be used in the invention can be prepared. By way of the choice of the rate of supply of the monomers it allows the gradient to be controlled and thus allows a more differentiated designing of the gradient copolymer in order to match the transition from hydrophilic to hydrophobic properties along the polymer chain to the particular requirements.

The gradient must be such that one chain end is hydrophobic and the other chain end is hydrophilic. In order to assess the slope of the gradient it is possible to employ the difference in the solubility parameters between the hydrophilic and hydrophobic chain ends and also the distribution of the different monomers along the polymer chain.

Gradient copolymers are delimited from block copolymers by the fluid transition between the monomers A and B, as described above. Block copolymers have a sudden transition between the monomers in the polymer chain, defined as the boundary between the individual blocks. The preparation of block copolymers, as well, takes a different path. In the preparation of an AB block copolymer, for example, first monomer A is polymerized and then monomer B is added at a later point in time. Besides this batchwise addition to the reaction vessel a similar result can also be achieved by suddenly changing the compositions of the two monomers at certain points in time during the course of their continuous addition.

The invention accordingly provides for the use as dispersants of gradient copolymers obtainable by living controlled polymerization of ethylenically unsaturated monomers using a non-polymeric monofunctional initiator and possessing a transition from hydrophilic to hydrophobic properties along the polymer chain, by

a) supplying one monomer (I) continuously to a monomer (II) under reaction or

b) supplying one monomer (I) and one monomer (II) at different rates continuously to a reaction vessel for reaction,

with either the monomer (I) or the monomer (II) introducing into the gradient copolymer groups which as they are or after further chemical reaction of the gradient copolymer interact with the solid or solids to be dispersed, and the other monomer introducing into the gradient copolymer groups which are compatible with the liquid or solid dispersion medium, with either the monomer (I) or the products of the further chemical reaction of the monomer (I), on the one hand, or the monomer (II) or the products of the further chemical reaction of the monomer (II) on the other hand, possessing hydrophobic properties and the other monomer in each case or the products of the further chemical reaction of the other monomer in each case possessing hydrophilic properties, the hydrophobic and hydrophilic properties being defined as follows:

hydrophilic properties are present when the solubility parameter is greater than or equal to 22 J^{1/2}/cm^{3/2} and hydrophobic properties are present when the solubility parameter is less than 22 J^{1/2}/cm^{3/2},

with the terms “monomer (I)” and “monomer (II)” embracing mixtures of monomers (I) on the one hand and monomers (II) on the other.

The non-polymeric monofunctional initiators used for this purpose start a polymer chain with only one direction of growth. The monofunctional initiators used in the respective living controlled polymerization method are known to the person skilled in the art.

Monofunctional initiators for atom transfer radical polymerization are for example

haloalkanes having 1 to 10 carbon atoms, such as carbon tetrabromide and 1,1,1-trichloroethane;

haloalcohols having 2 to 10 carbon atoms, such as 2,2,2-trichloroethanol;

2-halocarboxylic acid and the esters thereof with 2 to 20 carbon atoms, such as chloroacetic acid, 2-bromopropionic acid, methyl 2-bromopropionate, methyl 2-chloropropionate, ethyl 2-bromoisobutyrate and ethyl 2-chloroisobutyrate;

2-halocarbonitriles having 2 to 10 carbon atoms, such as 2-chloroacetonitrile and 2-bromopropionitrile; alkane- and arenesulphonyl chlorides having 2 to 10 carbon atoms, such as methanesulphonyl chloride and benzenesulphonyl chloride; and

1-aryl-1-haloalkanes having 7 to 20 carbon atoms, such as benzyl chloride, benzyl bromide and 1-bromo-1-phenylethane, for example.

For polymerization techniques 1)-4), 6) and 10) the initiators used are for example

azo initiators such as azodiisobutyronitrile, peroxide compounds, such as dibenzoyl peroxide and dicumyl peroxide

and also persulphates such as potassium peroxo-disulphate.

Furthermore it is prior art in the case of certain polymerization methods to use adducts of the initiator with the polymerization regulator, such as alkoxyamines for NMP, for example. Examples of this are specified in Chem. Rev. 2001, 101, 3661, “V. Approaches to alkoxyamines”.

In the case of GTP the initiators include silyl ketene acetals such as [(1-methoxy-2-methyl-1-propenyl)oxy]-trimethylsilane for example. Further examples may be found in U.S. Pat. No. 4,822,859, U.S. Pat. No. 4780554 and EP 0184692 B1.

The gradient copolymers for use as dispersants in accordance with the invention preferably have a number-average molecular weight Mₙ of from 2 000 to 20 000 g/mol.

As described in WO 97/28200 hydrophobic and hydrophilic monomers are classified as follows:

Hydrophilic monomers possess a solubility parameter of greater than or equal to 22 J^{1/2}/cm^{3/2}. Hydrophobic monomers possess a solubility parameter of less than 22 J^{1/2}/cm^{3/2}.

Depending on the application of the dispersant it is possible in principle for any ethylenically unsaturated monomers and products of a further chemical reaction of these monomers to act as A or B monomers, either the monomers A being hydrophobic and the monomers B hydrophilic or the monomers A being hydrophilic and the monomers B hydrophobic. In apolar media, for example, hydrophobic monomers are used as A monomers and hydrophilic monomers as B monomers. Dispersants for aqueous systems contain hydrophilic monomers as A monomers and hydrophobic monomers as B monomers, which attach to the solid.

Examples of ethylenically unsaturated monomers are given below, the term “(meth)acrylate” embracing both acrylates and methacrylates:

alkyl(meth)acrylates of straight-chain, branched or cycloaliphatic alcohols having 1 to 22 carbon atoms, such as methyl(meth)acrylate, ethyl(meth)acrylate, n-butyl (meth)acrylate, isobutyl(meth)acrylate, t-butyl (meth)acrylate, lauryl(meth)acrylate, 2-ethylhexyl (meth)acrylate, stearyl(meth)acrylate, cyclohexyl (meth)acrylate, isobornyl(meth)acrylate and t-butyl (meth)acrylate;

aryl(meth)acrylates, such as benzyl methacrylate or phenyl acrylate, the aryl radicals being in each case unsubstituted or substituted up to four times, such as 4-nitrophenyl methacrylate, for example;

acrylic acid, methacrylic acid, maleic acid and their salts;

anhydrides, such as maleic anhydride, for example;

hydroxyalkyl(meth)acrylates of straight-chain, branched or cycloaliphatic diols having 2 to 36 carbon atoms, such as

3-hydroxypropyl methacrylate, 3,4-dihydroxybutyl monomethacrylate, 2-hydroxyethyl(meth)acrylate, 4-hydroxybutyl (meth)acrylate, 2-hydroxypropyl methacrylate and 2,5-dimethyl-1,6-hexanediol monomethacrylate for example;

mono(meth)acrylates of ethers, polyethylene glycols, polypropylene glycols or mixed polyethylene/propylene glycols having 5 to 80 carbon atoms, such as tetrahydrofurfuryl methacrylate, methoxyethoxyethyl methacrylate, 1-butoxypropyl methacrylate, cyclohexyloxymethyl methacrylate, methoxymethoxyethyl methacrylate, benzyloxymethyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol) methyl ether (meth)acrylate, and poly(propylene glycol) methyl ether (meth)acrylate, for example;

caprolactone- and/or valerolactone-modified hydroxyalkyl (meth)acrylates having an average molecular weight M, of from 220 to 1200, the hydroxy (meth)acrylates being derived preferably from straight-chain, branched or cycloaliphatic diols having 2 to 8 carbon atoms;

aminoalkyl(meth)acrylates, such as N,N-dimethylaminoethyl (meth)acrylate, 2-trimethylammonioethyl methyl methacrylate chloride and N,N-dimethylaminopropyl (meth)acrylate, for example;

(meth)acrylates of halogenated alcohols, such as perfluoroalkyl(meth)acrylates having 6 to 20 carbon atoms for example;

oxiranyl(meth)acrylates such as 2,3-epoxybutyl methacrylate, 3,4-epoxybutyl methacrylate and glycidyl (meth)acrylate for example;

styrene and substituted styrenes, such as 4-methylstyrene, 4-vinylbenzoic acid and sodium 4-vinylbenzenesulphonate, for example;

methacrylonitrile and acrylonitrile; ethylenically unsaturated heterocycles, such as 4-vinylpyridine and 1-[2-(methacryloyloxy)ethyl]-2-imidazolidinone, for example;

monomers containing phosphoric acid, such as tripropylene glycol methacrylate phosphate, for example;

ethylenically unsaturated sulphonic acids and sulphates and also their salts, such as potassium [3-(methacryloyloxy)propyl]sulphonate and ammonium [2-(methacryloyloxy)ethyl]sulphate, for example;

vinyl esters of carboxylic acids having 1 to 20 carbon atoms, such as vinyl acetate, for example;

maleimide, N-phenylmaleimide, and N-substituted maleimides with straight-chain, branched or cycloaliphatic alkyl groups having 1 to 22 carbon atoms, such as N-ethylmaleimide and N-octylmaleimide, for example;

(meth)acrylamide;

N-alkyl- and N,N-dialkyl-substituted acrylamides with straight-chain, branched or cycloaliphatic alkyl groups having 1 to 22 carbon atoms, such as N-(t-butyl)acrylamide and N,N-dimethylacrylamide, for example;

silyl-containing (meth)acrylates, such as (meth)acrylic acid trimethylsilyl ester and methacrylic acid 3-(trimethylsilyl)propyl ester, for example.

To prepare the gradient polymers with a transition from hydrophilic to hydrophobic properties along a polymer chain the monomers A or the monomers B can be introduced together with the other components needed to carry out the polymerization, such as the monofunctional initiator and catalysts or polymerization regulator, for example, and the respective other monomers can be metered in at a constant rate. Both monomers, A and B, can be mixtures of different monomers and may further comprise solvents. Catalysts for ATRP are for example copper chloride complexes or copper bromide complexes with nitrogen ligands such as 2,2′-bipyridine or N,N,N′,N″,N″-pentamethyldiethylenetriamine, which can also be generated in situ from copper metal, ligand and initiator. Other catalysts are listed in Chem. Rev. 2001, 101, 2921.

Hydrophobic monomers useful in practicing the invention include (C₁-C₂₂) alkyl(meth)acrylic ester such as, for example, methyl(meth)acrylate, ethyl(meth)acrylate, n-butyl(meth)acrylate, isobutyl(meth)acrylate, t-butyl (meth)acrylate, lauryl(meth)acrylate, 2-ethylhexyl (meth)acrylate, stearyl(meth)acrylate, cyclohexyl(meth)acrylate, isobornyl(meth)acrylate and t-butyl(meth)acrylate, and the like;

aryl(meth)acrylates, such as benzyl methacrylate, phenyl acrylate, nitrophenyl methacrylate, and the like;

styrene and substituted styrenes, such as, for example, 4-methylstyrene, and the like;

vinyl esters of carboxylic acids having 1 to 20 carbon atoms, such as, for example, vinyl acetate, and the like.

Hydrophilic monomers useful in practicing the invention include vinyl carboxylic acids such as, for example, acrylic acid, methacrylic acid, maleic acid, salts thereof, and the like;

mono(meth)acrylates of ethers, polyethylene glycols, polypropylene glycols or mixed polyethylene/propylene glycols having 5 to 80 carbon atoms, such as, for example, tetrahydrofurfuryl methacrylate, methoxyethoxyethyl methacrylate, 1-butoxypropyl methacrylate, cyclohexyloxymethyl methacrylate, methoxymethoxyethyl methacrylate, benzyloxymethyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol) methyl ether (meth)acrylate, and poly(propylene glycol) methyl ether (meth)acrylate, and the like; and (meth)acrylamides.

For GTP the catalysts used include fluorides, described in U.S. Pat. No. 4,659,782, and oxyanions, described in U.S. Pat. No. 4,588,795. One preferred catalyst for GTP is tetrabutylammonium m-chlorobenzoate. For polymerization techniques 1)-6), 8) and 10) examples of polymerization regulators are listed in the cited literature; for NMP such a regulator is 2,2,6,6-tetramethylpiperidineoxyl (TEMPO) or N-tert-butyl-N-[1-diethylphosphono(2,2-dimethylpropyl)]nitroxyl, for example; for the polymerization technology 6 such a regulator is 1,1-diphenylethene; for RAFT such regulators are for example thiocarboxylic esters or xanthogenates.

Another suitable process for preparing the gradient polymers with a transition from hydrophilic to hydrophobic properties along the polymer chain is the separate applying of the monomers A and monomers B at different rates to the reaction vessel, which contains solvents and the other components needed to carry out the polymerization. In this case as well it is possible for both monomers—monomers A and monomers B—to be mixtures of different monomers, and they may further comprise solvents. The amount of the monomer B is preferably 10-50% by weight of the polymer.

The metering rate depends on the polymerization rate. It should preferably be chosen such that at the end of the addition of the second monomer to the monomer included in the initial charge or at the end of the addition of the monomer with the slower metering rate the first monomer, which is introduced initially or supplied to the reaction at the faster metering rate, has been consumed.

In accordance with the polymerization method suitable reaction conditions, monomers and solvents known to the person skilled in the art are to be chosen.

When polymerization has taken place the polymers can be modified subsequently in polymer-analogous reactions in order for example to generate attachment groups. It is possible to react acid functions in the polymer such as carboxylic acids and phosphoric esters, for example, with bases.

Examples of Bases are:

amines such as dimethylaminoethanol, diethanolamine, triethanolamine, 2-(dimethylamino)propan-1-ol, triethylamine, butylamine and dibutylamine, for example,

hydroxides, oxides, carbonates and hydrogencarbonates of metals of groups 1-3, such as sodium hydroxide, potassium hydroxide, aluminum hydroxide and sodium hydrogencarbonate, for example;

and heterocyclic nitrogen compounds such as imidazole, for example.

As described for example in U.S. Pat. No. 6,111,054 it is also possible to form salts of amines attached to the polymer using carboxylic acids, sulphonic acids or phosphoric acids and their esters.

A further possibility is to convert amines into quaternary ammonium salts in alkylation reactions with benzyl chloride, for example. Tertiary amines can be converted with oxygen, peroxo compounds such as percarboxylic acids and with hydrogen peroxide into amine oxides, which can additionally be converted to a salt form with acids such as hydrochloric acid, for example.

Oxirane structures in the polymer can be reacted with nucleophiles such as 4-nitrobenzoic acid, amines such as ethanolamine or dibutylamine, or polyphosphoric acid. Hydroxy functionalities in the polymer can be reacted with polyphosphoric acid to give phosphoric esters or with lactones such as ε-caprolactone, for example, to give polyesters.

Dispersants based on gradient copolymers with a transition from hydrophilic to hydrophobic properties along the polymer chain can be used in accordance with the state of the art for known dispersants. The pigment dispersions comprising these dispersants can be utilized in a multiplicity of applications, for example for the dispersing of solids in organic solvents and/or water, where appropriate in the presence of binders and customary coating auxiliaries, or for the dispersing of solids in thermoplastic polymers.

For instance they can be used, for example, in the preparation of pigmented coating compositions such as paints, pastes and/or moulding compounds, for example. These dispersants can be used, for example, for preparing a pigmented paint, in which case a paint binder and/or solvents and also solids, i.e. pigments and, if desired, fillers and customary auxiliaries are mixed. Paint binders here are macromolecular substances or macromolecule formers which are responsible for film formation. Suitable coating materials include for example 2-component reactive coating materials, air-drying coating materials, moisture-curing coating materials, acid-curing coating materials, radiation-curing coating materials, emulsion paints or baking enamels. Examples that may be mentioned include vinyl ester resins, alkyd resins, polyester resins, polyurethane resins, unsaturated polyester resins, polyester/polyisocyanate combinations, acrylic resins, epoxy resins, epoxy resin esters, ethylene-vinyl acetate polymers, melamine-formaldehyde resins, phenol-formaldehyde resins, polymethyl methacrylate, polypropylene, polyethylene, polyamides, polystyrene, polyurethane, polyvinyl acetate, polyvinyl butyrate, polyvinyl chloride, polyvinylidene chloride, polyvinylidene fluoride, polyvinyl fluoride, chlorinated rubber, cyclo rubber, silicone polymers, urea-formaldehyde resins, vinyl chloride-vinyl acetate polymers, polybutadienes, and so on, also mixtures of the aforementioned substances. Additionally in the binders it is also possible for crosslinking monomers, with two nonconjugated ethylenically unsaturated double bonds, to be present. Examples thereof are divinylbenzene, alkylene glycol di(meth)acrylates, such as ethylene glycol diacrylate, 1,3-propylene glycol diacrylate, 1,2-propylene glycol dimethacrylate, and allyl (meth)acrylate, diallyl maleate, triallylcyanuric acid or triallylisocyanuric acid.

The invention further provides for the use of the above-described gradient copolymers as dispersants in the preparation of pigmented moulding compounds or moulding compounds filled with other solids and of a pigmented coating on a substrate, the pigmented paint being applied to the substrate and then baked or cured or crosslinked. The dispersants can be used alone or together with binders with no functional attachment. In the case of using polyolefines it may be advantageous, for example, to use waxes as carrier material together with the dispersant.

An inventive use of the above-described gradient copolymers as dispersants also consists in the preparation of dispersible pigments which have been coated with the dispersant. Coating of the pigments in this way is carried out in conventional fashion, as described for example in EP-A-0270126.

Further examples of the use of pigment dispersions are set out in WO 00/40630, page 3 lines 15-30.

The dispersants can be used to disperse organic pigments, such as azo and diazo condensates and the metal complexes thereof, for example, phthalocyanines, quinacridones, indoles, thioindoles, perylenes, anthraquinones, anthrapyrimidines, diketopyrrolo-pyrroles and carbazoles. Further examples of pigments can be found in the monograph by W. Herbst and K. Hunger, “Industrial Organic Pigments”, 1997, Wiley-VCH, ISBN: 3-527-28836-8.

In addition it is possible to disperse inorganic pigments and other solids such as, for example, aluminium, iron(III) oxide, chromium(III) oxide, titanium dioxide, zirconium dioxide, zinc oxide, zinc sulphide, zinc phosphate, molybdenum sulphide, cadmium sulphide, carbon black, graphite, bismuth vanadate, lead chromate, lead molybdate, rutile, calcium carbonate, magnesium hydroxide, glass fibers or silicates.

The choice of the monomers B is guided by the pigment or solid to be dispersed and can be different from one case to another. The same applies to the choice of the monomers A, which should be matched to the liquid or solid medium: for example, it is advantageous to match the polarity of the monomers A to the polarity of the binders, resins or thermoplastic polymers and also to the solvents used.

### PREPARATION EXAMPLES

Preparation of the Polymers:

The polymers prepared, along with the quantities and metering rates, are summarized in Tables 1 and 2.

General Procedure for Preparing the Gradient Polymers P1-P15 by Means of ATRP:

In a glass flask provided with stirrer, thermometer, reflux condenser and nitrogen inlet tube monomers 1 and 2, benzene sulphochloride BSCI, 1 g of 2,2′-bipyridine and 400 mg of copper powder in 25 ml of methoxypropyl acetate (PMA) were heated to 100° C. under an N₂ atmosphere. When reaction commenced monomer 3 in x g of PMA was added dropwise at a constant metering rate x. After the end of the supply of the monomer 3 and a subsequent reaction time of 5 minutes the reaction was terminated by ingress of air. Following dilution of the reaction mixture with 100 g of PMA it was filtered over silica gel in order to separate off impurities. The volatile constituents were subsequently removed by distillation. The average molecular weight was determined by gel permeation chromatography using polymethyl methacrylate as the standard for comparison.

General Procedure for Preparing the AR Block Copolymers P16-P20 by Means of ATRP:

In a glass flask provided with stirrer, thermometer, reflux condenser and nitrogen inlet tube monomer 1, 3.3 ml of BSCI, 1 g of 2,2′-bipyridine and 400 mg of copper powder in 25 ml of PMA were heated to 100° C. under an N₂ atmosphere. After a conversion of at least 98%, determined by ¹H-NMR spectroscopy, monomer 3 in 123 g of PMA was added over the course of 1 minute and polymerized to a conversion of at least 98%. The reaction was terminated by ingress of air. After dilution of the reaction mixture with 100 g of PMA it was filtered over silica gel in order to separate off impurities. The volatile constituents were subsequently removed by distillation. The average molecular weight was determined by gel permeation chromatography using polymethyl methacrylate as the standard for comparison.

Preparation of the Random Copolymer P21:

In a glass flask provided with stirrer, thermometer, reflux condenser and nitrogen inlet tube 148 g of PMA were introduced at 135° C. under an N₂ atmosphere and a mixture of monomer 1, monomer 3 and 3.4 g of Trigonox C was added dropwise at a metering rate of 0.6 ml/min. After the end of the addition and a further 2 hours at 135° C. the volatile constituents were removed by distillation. The number-average molecular weight was determined by gel permeation chromatography using polymethyl methacrylate as the standard for comparison.

Preparation of the Dispersants:

The dispersants prepared are listed in Table 3.

Preparation of Dispersants D1-D9 from Polymers P1-P7, P16 and P21:

168 g of each of the polymers P1, P2, P5-7, P16 and P21, 158 g of P3 or 180 g of P4 were reacted with 52 g of benzyl chloride in 150 g of PMA and 150 g of butylglycol (BG) at 100° C. for 2 hours and the product was then diluted with a 1:1 mixture of PMA and butylglycol to a solids content of 40%.

Preparation of the Dispersants D10-D14 from Polymers P1, P2, P15, P16 and P20:

The polymer P was diluted with PMA to a solids content of 40%.

Preparation of Dispersants D15-D17 from polymers P8, P9 and P17:

The polymer P was reacted with a five-fold molar excess of 32% strength aqueous hydrochloric acid relative to the number of t-butyl groups in the polymer and 200 ml of dioxane at 90° C. for 4 hours. The polymer was precipitated from water, dried and diluted with a 1:1 mixture of water and butylglycol, 16 g of triethanolamine to a solids content of 40%.

Preparation of Dispersants D18-D20 from polymers P10, P11 and P18:

The polymer P was reacted with 55 g of 4-nitrobenzoic acid and 1 g of ethyltriphenylphosphonium iodide in 250 g of PMA at 110° C. for 8 hours and subsequently adjusted to a solids content of 40%.

Preparation of Dispersants D21-D24 from Polymers P12-P14 and P19:

33 g of polyphosphoric acid or 66 g of polyphosphoric acid for P14 were added in portions at 50° C. to the polymer P in 200 g of PMA and these compounds were reacted at 80° C. for 3 hours. The solutions were subsequently adjusted to a solids content of 40%.

TABLE 1
Gradient copolymers prepared by ATRP

| Polymer | BSCI | Monomer 1 | | Monomer 2 | | Monomer 3 | | PMA | Metering rate | Mₙ | M_{w}/Mₙ |
|---|---|---|---|---|---|---|---|---|---|---|---|
| P1 | 3.3 ml | BMA | 103 g | — | — | DMAEMA | 65 g | 123 g | 0.8 ml/min | 6700 | 1.35 |
| P2 | 3.3 ml | BMA | 103 g | — | — | DMAEMA | 65 g | 123 g | 1.6 ml/min | 9210 | 1.27 |
| P3 | 3.3 ml | BMA | 71 g | MMA | 22 g | DMAEMA | 65 g | 123 g | 1.6 ml/min | 6440 | 1.26 |
| P4 | 3.3 ml | BMA | 71 g | EHMA | 44 g | DMAEMA | 65 g | 123 g | 0.8 ml/min | 7400 | 1.28 |
| P5 | 6.6 ml | BMA | 103 g | — | — | DMAEMA | 65 g | 123 g | 1.6 ml/min | 3240 | 1.34 |
| P6 | 3.3 ml | BMA | 206 g | — | — | DMAEMA | 130 g | 246 g | 1.6 ml/min | 14230 | 1.27 |
| P7 | 3.3 ml | BMA | 309 g | — | — | DMAEMA | 195 g | 369 g | 1.6 ml/min | 20540 | 1.26 |
| P8 | 3.3 ml | BMA | 103 g | — | — | t-BMA | 60 | 123 g | 0.8 ml/min | 6910 | 1.29 |
| P9 | 3.3 ml | BMA | 103 g | — | — | t-BMA | 60 g | 123 g | 1.6 ml/min | 6890 | 1.26 |
| P10 | 3.3 ml | BMA | 103 g | — | — | GMA | 59 g | 123 g | 0.8 ml/min | 6960 | 1.34 |
| P11 | 3.3 ml | BMA | 103 g | — | — | GMA | 59 g | 123 g | 1.6 ml/min | 7290 | 1.38 |
| P12 | 3.3 ml | BMA | 103 g | — | — | HEMA | 54 g | 123 g | 0.8 ml/min | 6780 | 1.30 |
| P13 | 3.3 ml | BMA | 103 g | — | — | HEMA | 54 g | 123 g | 1.6 ml/min | 6970 | 1.28 |
| P14 | 3.3 ml | BMA | 206 g | — | — | HEMA | 108 g | 246 g | 1.6 ml/min | 12450 | 1.29 |
| P15 | 3.3 ml | BMA | 103 g | — | — | MIMI | 82 g | 123 g | 1.6 ml/min | 6720 | 1.25 |

BSCI = benzene sulphochloride,
BMA = n-butyl methacrylate,
MMA = methyl methacrylate,
EHMA = 2-ethylhexyl methacrylate,
DMAEMA = N,N-dimethylaminoethyl methacrylate,
t-BMA = t-butyl methacrylate,
GMA = glycidyl methacrylate,
HEMA = 2-hydroxyethyl methacrylate,
MIMI = 1-[2-(methacryloyloxy)-ethyl]-2-imidazolidinone

TABLE 2
Block copolymers prepared and the random copolymer P21 prepared

| Polymer | BSCI | Monomer 1 | | Monomer 2 | Monomer 3 | | Mₙ | M_{w}/Mₙ |
|---|---|---|---|---|---|---|---|---|
| P16 | 3.3 ml | BMA | 103 g | | DMAEMA | 65 g | 6781 | 1.26 |
| P17 | 3.3 ml | BMA | 103 g | | t-BMA | 60 g | 7590 | 1.32 |
| P18 | 3.3 ml | BMA | 103 g | | GMA | 59 g | 7130 | 1.27 |
| P19 | 3.3 ml | BMA | 103 g | | HEMA | 54 g | 7030 | 1.27 |
| P20 | 3.3 ml | BMA | 103 g | | MIMI | 82 g | 5560 | 1.50 |
| P21 | | BMA | 103 g | | DMAEMA | 65 g | 9200 | 2.49 |

TABLE 3
Reaction products or dilutions of polymers P1-P21

| Dispersant | Polymer | Polymer structure | Reaction | Solvent(s) |
|---|---|---|---|---|
| D1 | P21 | random copolymer | with benzyl chloride | PMA/BG, 50:50 |
| D2 | P16 | block copolymer | with benzyl chloride | PMA/BG, 50:50 |
| D3 | P1 | gradient copolymer | with benzyl chloride | PMA/BG, 50:50 |
| D4 | P2 | gradient copolymer | with benzyl chloride | PMA/BG, 50:50 |
| D5 | P3 | gradient copolymer | with benzyl chloride | PMA/BG, 50:50 |
| D6 | P4 | gradient copolymer | with benzyl chloride | PMA/BG, 50:50 |
| D7 | P5 | gradient copolymer | with benzyl chloride | PMA/BG, 50:50 |
| D8 | P6 | gradient copolymer | with benzyl chloride | PMA/BG, 50:50 |
| D9 | P7 | gradient copolymer | with benzyl chloride | PMA/BG, 50:50 |
| D10 | P16 | block copolymer | | PMA |
| D11 | P1 | gradient copolymer | | PMA |
| D12 | P2 | gradient copolymer | | PMA |
| D13 | P20 | block copolymer | | PMA |
| D14 | P15 | gradient copolymer | | PMA |
| D15 | P17 | block copolymer | acidic hydrolysis | BG/water, 50:50 |
| D16 | P8 | gradient copolymer | acidic hydrolysis | BG/water, 50:50 |
| D17 | P9 | gradient copolymer | acidic hydrolysis | BG/water, 50:50 |
| D18 | P18 | block copolymer | with p-nitrobenzoic acid | PMA |
| D19 | P10 | gradient copolymer | with p-nitrobenzoic acid | PMA |
| D20 | P11 | gradient copolymer | with p-nitrobenzoic acid | PMA |
| D21 | P19 | block copolymer | with polyphosphoric acid | PMA |
| D22 | P12 | gradient copolymer | with polyphosphoric acid | PMA |
| D23 | P13 | gradient copolymer | with polyphosphoric acid | PMA |
| D24 | P14 | gradient copolymer | with polyphosphoric acid | PMA |

Paints Made Up With the Dispersants:

Performance of the Foam Test:

40 g of paint were foamed at 1895 rpm for 1 minute using a dissolver from the company Pendraulik and immediately poured out. After drying, the foam was assessed on the following scale:

1-5 (1=no foam; 5=lots of foam)

The gloss and haze were determined using the “haze-gloss” measuring instrument from the company Byk Gardner. The transparency and formation of specks were assessed visually. This was done using a scale of 1 to 5 (1=no specks or transparent; 5=lots of specks or not transparent).

D1-D9, D13 and D14: Gas black FW 200, acidic carbon black type, manufacturer: Degussa

Milling paste:

| | |
|---|---|
| Dynapol H703 (65% in xylene) | 49.00 g |
| dispersant D | 14.00 g |
| pigment | 8.00 g |
| butyl acetate | 29.00 g |
| | 100.00 g |

Dispersing: 60 minutes at 40° C. and 10000 rpm, Dispermat CV

Make-up material:

| | |
|---|---|
| Dynapol H703 (65% in xylene) | 34.70 g |
| CAB 381-2 | 42.60 g |
| (15% in 2:1 butyl acetate/xylene) | |
| Maprenal MF 650 | 20.90 g |
| (55% in iso-butanol) | |
| BYK 306 | 1.80 g |
| | 100.00 g |

Make-up:

| | |
|---|---|
| milling paste | 13.20 g |
| make-up material | 36.30 g |
| butyl acetate | 50.00 g |
| | 100.00 g |

Shake for 10 minutes

Drying: 10 min at room temperature, then 30 min at 140° C.

Assessment of the Paint Film:

| | | | | Gel | |
|---|---|---|---|---|---|
| | Gloss R20 | Haze | Transparency | specks | Foam |
| D1 | 26 | 465 | 5 | no | 2 |
| D2 | 93 | 39 | 2 | yes | 5 |
| D3 | 90 | 42 | 1 | no | 3-4 |
| D4 | 88 | 29 | 1 | no | 3-4 |
| D5 | 88 | 24 | 1 | no | 3-4 |
| D6 | 102 | 32 | 2 | no | 3-4 |
| D7 | 89 | 29 | 1 | no | 3-4 |
| D8 | 86 | 34 | 1 | no | 3-4 |
| D9 | 87 | 35 | 2 | no | 3-4 |
| D13 | 47 | 349 | 1 | no | 4 |
| D14 | 90 | 34 | 1 | no | 3 |

D10-D12: Irgazine DPPredBO, manufacturer: Ciba Specialty Chemicals

Milling paste:

| | |
|---|---|
| Paraloid DM 55 | 30.00 g |
| (60% in 1:1 xylene/PMA) | |
| PMA | 16.40 g |
| dispersant D | 20.60 g |
| pigment | 33.00 g |
| | 100.00 g |

Dispersing: 45 min at 40° C. and 10000 rpm, Dispermat CV

Make-up material:

| | |
|---|---|
| Polymac 57-5776 (85% in PMA) | 61.00 g |
| Cymel 303 | 17.40 g |
| PMA | 8.10 g |
| butanol | 2.80 g |
| 2-butanone | 2.60 g |
| xylene | 4.60 g |
| Byk Cat 450 | 3.50 g |
| | 100.00 g |

Make-up:

30.3 g of paste and 69.3 g of make-up material; shake for 10 minutes

Drying: 10 min at room temperature, then 30 min at 140° C.

Assessment of the Paint Film:

| | Gloss | | | | |
|---|---|---|---|---|---|
| | R20 | Haze | Transparency* | Specks | Foam |
| D10 | 31 | 318 | | no | 3 |
| D11 | 46 | 285 | | no | 3 |
| D12 | 37 | 311 | | no | 3 |

*opaque pigment, impossible to measure transparency

D15 and D16: Sicotransred L2817, manufacturer: BASF

Milling paste:

| | |
|---|---|
| PEG 200 | 16.00 g |
| H₂O distilled | 38.10 g |
| dispersant D | 15.00 g |
| Byk 024 | 0.40 g |
| Byk 019 | 0.50 g |
| pigment | 30.30 g |
| | 100.00 g |

Dispersing: 45 min at 40° C. and 10000 rpm, Dispermat CV

Make-up material:

| | |
|---|---|
| Neocryl XK 97 (42.5% in water) | 95.00 g |
| ammonia (adjust pH to 9) | |
| butyldiglycol | 2.30 g |
| Acrysol RM 8 | 0.50 g |
| Borchigel L 75 N | 1.00 g |
| (50% in water) | |
| Byk 028 | 1.00 g |
| Byk 346 | 0.20 g |
| | 100.00 g |

Make-up:

26.30 g of paste and 73.70 g of varnish; shake for 10 minutes

Drying: at room temperature

Assessment of the paint film:

| | Gloss | | | | Foam |
|---|---|---|---|---|---|
| | R20 | Haze | Transparency* | Specks | height |
| D15 | 6 | 246 | 4 | yes | 1.5 cm |
| D16 | 13 | 207 | 4 | no | 1.0 cm |

*3 g of paint shaken in 20 g of water; assessment of the foam height after 1 h.

D18-D20: Printex 200, basic carbon black type, manufacturer: Degussa

Milling paste:

| | |
|---|---|
| Dynapol H703 (65% in xylene) | 49.00 g |
| dispersant D | 14.00 g |
| pigment | 8.00 g |
| butyl acetate | 29.00 g |
| | 100.00 g |

Dispersing: 60 min at 40° C. and 10000 rpm, Dispermat CV

Make-up material:

| | |
|---|---|
| Dynapol H703 (65% in xylene) | 34.70 g |
| CAB 381-2 | 42.60 g |
| (15% in 2:1 butyl acetate/xylene | |
| Maprenal MF 650 | 20.90 g |
| (55% in 2-butanol) | |
| BYK 306 | 1.80 g |
| | 100.00 g |

Make-up:

| | |
|---|---|
| Milling paste | 13.20 g |
| Make-up material | 36.30 g |
| butyl acetate | 50.50 g |
| | 100.00 g |
| Shake for 10 minutes | |

Drying: 10 min at room temperature, then 30 min at 140° C.

Assessment of the Paint Film:

| | Gloss | | | | |
|---|---|---|---|---|---|
| | R20 | Haze | Transparency | Specks | Foam |
| D18 | 34 | 453 | 4 | no | 5* |
| D19 | 45 | 402 | 4 | no | 1* |
| D20 | 50 | 390 | 4 | no | 1* |

*assessment of the foaming of the milling paste

D21-D24: Sicotransred L2817, manufacturer: BASF Milling paste:

| | |
|---|---|
| Paraloid DM 55 | 33.00 g |
| (60% in 1:1 xylene/PMA) | |
| PMA | 18.25 g |
| dispersant D | 18.75 g |
| pigment | 30.00 g |

100.00 g

Dispersing: 45 min at 40° C. and 10000 rpm, Dispermat CV

Make-up material:

| | | |
|---|---|---|
| Polymac 57-5776 | 61.00 | g |
| (85% in PMA) | | |
| Cymel 303 | 17.40 | g |
| PMA | 8.10 | g |
| butanol | 2.80 | g |
| 2-butanone | 2.60 | g |
| xylene | 4.60 | g |
| Byk Cat 450 | 3.50 | g |
| | 100.00 | g |

Make-up:

12 g of paste and 88 g of varnish; Shake for 10 minutes

Drying: 10 min at room temperature, then 30 min at 140° C.

Assessment of the Paint Film:

| | Gloss | | | | |
|---|---|---|---|---|---|
| | R20 | Haze | Transparency | Specks | Foam |
| D21 | 29 | 535 | 5 | no | 5 |
| D22 | 85 | 97 | 2 | no | 1 |
| D23 | 89 | 65 | 2 | no | 1 |
| D24 | 88 | 70 | 2 | no | 1 |

| | |
|---|---|
| Dynapol H703: | saturated polyester, binder, Degussa |
| Maprenal MF 650: | melamine resin, binder, Vianova |
| Paraloid DM 55: | polymethacrylate, binder, Rohm and |
| Haas | |
| Polymac 57-5776: | polyester, binder, McWhorter |
| Neocryl XK-97: | polymethacrylate, binder, Neo-Resins |
| Byk Cat 450: | catalyst, Byk-Chemie |
| Byk 019: | defoamer, Byk-Chemie |
| Byk 024: | defoamer, Byk-Chemie |
| Byk-028: | defoamer, Byk-Chemie |
| Byk 306: | levelling additive, Byk-Chemie |
| Byk 346: | silicone surfactant, Byk-Chemie |
| Acrysol RM 8: | thickener, Rohm and Haas |
| Borchigel L75N: | thickener, Borchers |
| Cymel 303: | melamine resin, binder, Cytec |
| PEG: | polyethylene glycol |
| CAB: | cellulose acetobutyrate |

All publications, patents, and patent documents, cited in this application, are herein incorporated by reference, as though individually incorporated by reference.

1. Use as dispersants of gradient copolymers obtainable by living controlled polymerization of ethylenically unsaturated monomers using a non-polymeric monofunctional initiator and possessing a transition from hydrophilic to hydrophobic properties along the polymer chain, by
a) supplying one monomer (I) continuously to a monomer (II) under reaction or
b) supplying one monomer (I) and one monomer (II) at different rates continuously to a reaction vessel for reaction,
with either the monomer (I) or the monomer (II) introducing into the gradient copolymer groups which as they are or after further chemical reaction of the gradient copolymer interact with the solid or solids to be dispersed, and the other monomer introducing into the gradient copolymer groups which are compatible with the liquid or solid dispersion medium, with either the monomer (I) or the products of the further chemical reaction of the monomer (I), on the one hand, or the monomer (II) or the products of the further chemical reaction of the monomer (II) on the other hand, possessing hydrophobic properties and the other monomer in each case or the products of the further chemical reaction of the other monomer in each case possessing hydrophilic properties, the hydrophobic and hydrophilic properties being defined as follows:
hydrophilic properties are present when the solubility parameter is greater than or equal to 22 J^{1/2/}cm^{3/2} and hydrophobic properties are present when the solubility parameter is less than 22 J^{1/2}/cm^{3/2},
with the terms “monomer (I)” and “monomer (II)” embracing mixtures of monomers (I) on the one hand and monomers (II) on the other.

2. Use according to claim 1, wherein the living controlled polymerization is atom transfer radical polymerization.

3. Use according to claim 1, wherein the living controlled polymerization is group transfer polymerization.

4. Use according to claim 1, wherein the living controlled polymerization is RAFT polymerization.

5. Use according to claim 1, wherein the living controlled polymerization is conducted with 1,1-diphenylethene.

6. Use according to claim 1, wherein the living controlled polymerization is conducted with nitroxyl compounds (NMP).

7. Use according to claim 1, wherein the living controlled polymerization is conducted with organocobalt complexes.

8. Use according to any of claims 1-7, wherein the gradient copolymers possess a number-average molecular weight Mn of from 2 000 to 20 000 g/mol.

9. Use according to any of claims 1-8, wherein the monomers which interact with the solid or solids to be dispersed are selected from the group consisting of aminoalkyl (meth)acrylates whose amine functionality has either been converted to the salt form using acids or reacted with alkylating agents to form quaternary ammonium groups, and 1-[2-(methacryloyloxy)ethyl]-2-imidazolidinone.

10. Use according to one or more of claims 1-9 for dispersing solids in organic solvents and/or water, where appropriate in the presence of binders and customary coating auxiliaries.

11. Use according to claim 10, wherein the solids are pigments and/or fillers.

12. Use according to one or more of claims 1-9 for preparing a coating composition, wherein a binder, one or more organic solvents and/or water, pigments and/or fillers, the dispersant and, if desired, further customary auxiliaries are dispersed together.

13. Use according to one or more of claims 1-12, wherein the solids to be dispersed are coated with the gradient copolymers.

14. Coating compositions, pastes and/or moulding compounds comprising as dispersants gradient copolymers obtainable by living controlled polymerization of ethylenically unsaturated monomers using a non-polymeric monofunctional initiator and possessing a transition from hydrophilic to hydrophobic properties along the polymer chain, by
a) supplying one monomer (I) continuously to a monomer (II) under reaction or
b) supplying one monomer (I) and one monomer (II) at different rates continuously to a reaction vessel for reaction,
with either the monomer (I) or the monomer (II) introducing into the gradient copolymer groups which as they are or after further chemical reaction of the gradient copolymer interact with the solid or solids to be dispersed, and the other monomer introducing into the gradient copolymer groups which are compatible with the liquid or solid dispersion medium, with either the monomer (I) or the products of the further chemical reaction of the monomer (I), on the one hand, or the monomer (II) or the products of the further chemical reaction of the monomer (II) on the other hand, possessing hydrophobic properties and the other monomer in each case or the products of the further chemical reaction of the other monomer in each case possessing hydrophilic properties, the hydrophobic and hydrophilic properties being defined as follows:
hydrophilic properties are present when the solubility parameter is greater than or equal to 22 J^{1/2}/cm^{3/2} and hydrophobic properties are present when the solubility parameter is less than 22 J^{1/2}/cm^{3/2},
with the terms “monomer (I)” and “monomer (II)” embracing mixtures of monomers (I) on the one hand and monomers (II) on the other.

15. Coating compositions, pastes and/or moulding compounds according to claim 14, wherein the gradient copolymers possess a number-average molecular weight Mₙ of from 2 000 to 20 000 g/mol.

16. Coating compositions, pastes and/or moulding compounds according to one or both of claims 14 and 15, comprising one or more solids, organic solvents and/or water, where appropriate in the presence of binders and customary coating auxiliaries.

17. Coating compositions, pastes and/or moulding compounds according to claim 16, wherein the solid or solids are pigments and/or fillers.

18. Coating compositions, pastes and/or moulding compounds according to claim 16 or 17, wherein the solid or solids are coated with the gradient copolymer.

19. Coating compositions, pastes and/or moulding compounds according to claim 16 or 17, wherein the hydrophobic monomer is an alkyl (meth)acrylic ester, vinyl acetete, styrene, substituted styrene, or vinyl ester.

20. Coating compositions, pastes and/or moulding compounds according to claim 16 or 17, wherein the hydrophilic monomer is a vinyl carboxylic acid, mono(meth)acrylates of an ethers, polyethylene glycols, polypropylene glycols or mixed polyethylene/propylene glycols; or (meth)acrylamide.
